(19) United States
(12) Patent Application Publication
(10) Pub. No.: US 2007/0143776 A1
(43) Pub. Date: Jun. 21, 2007

(54) VIEWER DATA COLLECTION IN A MULTI-ROOM NETWORK

(76) Inventor: SAMUEL H. RUSS, Lawrenceville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/564,347

(22) Filed: Nov. 29, 2006

Related U.S. Application Data
(63) Continuation-in-part of application No. 11/069,440, filed on Mar. 1, 2005.

(51) Int. Cl. H04H 9/00

(52) U.S. Cl. 725/14; 370/486; 725/35

(57) ABSTRACT

Viewer data collection in a multi-room system. A TV viewing log is created for each user or each device in a multi-room system. The log can be used to limit or monitor the amount of television watched in the household. The log allows more accurate viewer data collection to be collected, compressed, and then sent to the headend at off-peak hours.

### CROSS-REFERENCE TO RELATED PATENT APPLICATIONS

The present application is A Continuation In Part (CIP) of U.S. patent application Ser. No. 11/069,440 which was filed on Mar. 1, 2005. The present application claims priority to U.S. provisional application having Ser. No. 60/416,155 filed on Oct. 4, 2002; also, the present invention is related to U.S. patent application Ser. No. 10/212,017, which was filed on Aug. 2, 2002, and U.S. patent application Ser. No. 10/235,201, which was filed on Sep. 5, 2002, and U.S. patent application Ser. Nos. 10/263,160, 10/263,449, and 10/263,270 which were filed on Oct. 2, 2002, and U.S. patent application Ser. No. 10/403,485, which was filed on Mar. 31, 2003, and U.S. patent application Ser. No. 11/069,439 which was filed on Mar. 1, 2005, the disclosures and teachings of which are hereby incorporated by reference.

### FIELD OF THE INVENTION

This invention relates in general to broadband communications systems, and more particularly, to the field of monitoring and storing information pertaining to user behavior and responses to televised programs.

### BACKGROUND OF THE INVENTION

Broadband communications systems, such as satellite and cable television systems, are now capable of providing many services in addition to analog broadcast video. In implementing enhanced programming, the set-top terminal (STT), otherwise known as the set-top box, has become an important computing device for accessing various video services. In addition to supporting traditional analog broadcast video functionality, many STTs now also provide other functionality, such as, for example, an interactive program guide (IPG), picture-in-picture (PIP) viewing, video-on-demand (VOD), subscription video-on-demand (SVOD) and functionality traditionally associated with a conventional computer, such as e-mail. Recently new functionality has been added to conventional STTs—namely the ability to record an incoming video stream in digitized form onto a mass storage device, such as a hard disk drive, and play back that recorded video as desired by the user. This functionality has become known as a “digital video recorder” (DVR) or personal video recorder (PVR) and is viewed as a superior alternative to conventional video tape recorders for capture and subsequent playback of programming content.

A STT is typically connected to a television set and located at the home of the cable or satellite system subscriber. Since the STT is located at a subscriber's premises, it typically may be used by two or more users (e.g., household members). Television has become so prevalent in the United States that the typical household may have two or more television sets, each television set requiring its own STT if the subscriber wishes to have access to enhanced functionality.

A networked multimedia system (NMS) is described in copending U.S. patent application Ser. No. 10/342,670, filed Jan. 15, 2003, the disclosure and teachings of which are hereby incorporated by reference. The NMS allows a plurality of remote devices in the premises to be locally networked (i.e., home-networked). One of the remote devices typically acts as the server or primary device (i.e., the primary set-top terminal (STT)) in the NMS. The primary device receives and forwards upon request broadband multimedia presentations (e.g., analog or digital television channels (i.e., audio/video signals), IP signals, video-on-demand (VOD) signals, administrative signals, etc.) throughout the local network to the plurality of remote devices (i.e., client devices). Furthermore, the remote devices are each capable of requesting and seamlessly receiving from the primary device resident presentations, such as a stored or recorded presentation, the interactive program guide, or the network guide, for example. Additionally, the remote devices may independently receive presentations from and send upstream signals to the communications network. Accordingly, the remote devices may be simplified, less-costly versions of the primary device but are capable of utilizing, via the NMS, some or all of the advanced hardware and software features, such as memory, a mass storage device, software applications, or infrastructure for transmitting signals back to the headend, that are available in the primary device.

Television viewership information and viewer behavioral characteristics and information are important factors and criteria for determining the costs and effectiveness of television programs. Televisions viewership is currently tracked by various means; most common is the Nielsen rating system which measures rankings of television programs by households. However, the Nielsen rating system has come under criticism from industry sources questioning its accuracy and effectiveness.

There exists a need for more accurate and detailed data collection system. Viewer data could be collected for each STT, for each user, or aggregated for an entire household. The viewer data could be provided to both the Nielsen rating system and to the users in the household. The viewer data could also be displayed as a log or used to limit television viewing by users in the household.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 is a simplified block diagram depicting a non-limiting example of a conventional broadband communications system with a networked multi-room system (NMS).

FIG. 2 illustrates a non-limiting example of one embodiment of an interactive program guide (IPG), which is suitable for use in the NMS of FIG. 1.

FIG. 3 illustrates the IPG of FIG. 2 further including functionality listings, such as a personal video recording (PVR) recorded list, the network guide (NG), and the TV viewing log, among others.

FIG. 4 depicts a non-limiting example of a TV viewing log that may be presented to a STT via the NMS of FIG. 1.

FIG. 5 illustrates a network guide screen in accordance with the present invention, which is suitable for use in the networked system of FIG. 1.

### DETAILED DESCRIPTION

The embodiments of the invention can be understood in the context of a broadband communications system and a local network system. Note, however, that the invention may be embodied in many different forms and should not be construed as limited to the embodiments set forth herein. For example, transmitted broadband signals may include at least one of video/audio, telephony, data, or Internet Protocol (IP) signals, to name but a few. Furthermore, remote devices included in the local network system receiving the transmitted broadband signals may include a set-top terminal (STT), a television, a computer, a personal digital assistant (PDA), or other display device. Moreover, in accordance with the present invention a multi-room interactive network guide can have various features, functions, and presentations when displayed. All examples given herein, therefore, are intended to be non-limiting and are provided in order to help clarify the description of the invention.

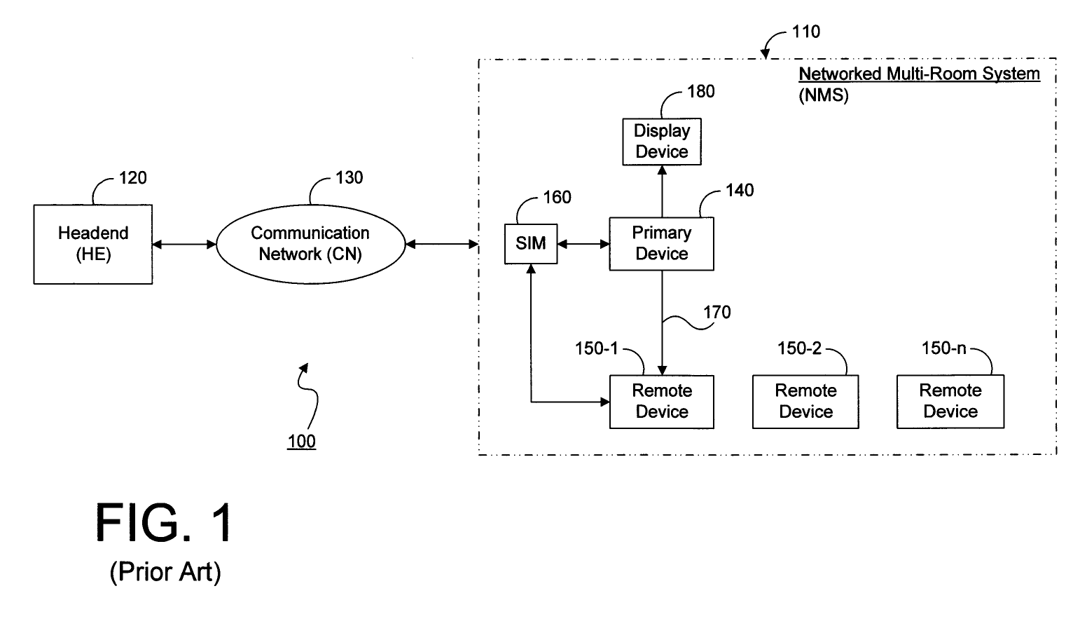

FIG. 1 is a simplified block diagram depicting a non-limiting example of a conventional broadband communications system 100. In this example, the communications system 100 includes a local networked multi-room system (NMS) 110 that is coupled to a headend (HE) 120 via a communications network (CN) 130. The CN 130 may be any network that is suitable for carrying, preferably downstream and upstream, broadband multimedia signals, such as audio/video signals, IP signals, telephony signals, or data signals to name but a few. The CN 130 may be, for example, a hybrid fiber/coax (HFC) network, a fiber-to-the-home (FITH) network, a satellite network, or a fixed wireless network (e.g., MMDS), among others.

The HE 120 may include one or more server devices for providing broadband signals, such as video, audio, and/or data signals, to a primary device 140 via the CN 130. The HE 120 and the primary device 140 cooperate to provide a user with a variety of services. The services may include, for example, analog or digital broadcast television services and channels, video-on-demand (VOD) services, and/or pay-per-view (PPV) services, among others. Each broadcast television channel typically provides a sequence of television presentations corresponding to a television station (e.g., ABC, NBC, CBS, or FNN) and is typically identified by a channel number (e.g., channel 2, channel 3, channel 4) that is available to a user at all times. Additionally, PPV services are typically transmitted to the primary device 140 at all times, but can only be viewed on the primary device 140 as provisioned. On the other hand, the primary device 140 typically requests a VOD service and, subsequently, the HE 120 transmits the presentation downstream to the primary device 140.

The NMS can include a router, but as shown in FIG. 1, the NMS 110 includes a splitter/isolator module (SIM) 160 that receives downstream broadband signals from the HE 120 and subsequently provides the downstream signals to the primary device 140 or to both the primary device 140 and any one or all of the remote devices 150-1 to 150-n depending on the implementation. Upon command from at least one of the remote devices 150-1 to 150-n, the primary device 140 may also forward selected real-time downstream signals and/or stored content signals to the requesting remote device 150-1, for example, via the SIM 160. The remote device 150-1 communicates with the primary device 140 by sending reverse control/command signals via coaxial cable requesting stored presentations, real-time signals, or the network guide. Other wired mediums, such as telephone lines or data cables, may be used so long as the transport format accommodates the desired transmission medium. The remote devices 150-1 to 150-n have access to all of the primary device 140's hardware and software functionality, along with receiving downstream signals directly from the headend via the SIM 160. Therefore, the remote devices 150-1 to 150-n may have limited resources, such as not including a storage device in order to record and store a presentation, thereby decreasing the overall costs to the service provider and the subscriber while offering advanced services to all of the remote devices 150-1 to 150-n that are networked to the primary device 140.

Furthermore, the primary device 140 may also directly provide signals, such as analog and digital channels, stored presentations, or the network guide to name but a few, to a coupled display device 180, which may be, for example, a television, computer, or PDA (personal digital assistant), among others. The primary device 140 may transmit signals to and receive control signals from the display device 180 via wireless devices (e.g., RF or IR devices) or a wired medium (e.g., coaxial cable, power lines, or telephone lines). It will also be appreciated that the primary device 140 may be incorporated in the display device 180.

The primary device 140, in accordance with one embodiment of the present invention, includes a processor, a tuner system, a storage device, a modulator, and a remote device communications receiver. Each of the remote devices, such as the remote device 150-1, may be identical to the primary device 140 and just share the storage device contents of the primary device 140. Alternatively, the remote device 150-1 may be a simplified or conventional version of the primary device 140. A processor and a tuner system, which may be a simplified processor and only one tuner, may be included to extract channels from the received downstream broadband signals. Additionally, decryptors and decoders may be included to decode encoded signals for proper processing and display. Preferably, the remote device 150-1 includes a user input receiver, such as an IR receiver or an RF receiver, that receives signals from a remote control, such as an IR remote control or an RF remote control. The remote control is not required and any user input device could be incorporated in the remote device 150-1.

In the event that the remote device 150-1, upon user input, requests a presentation, a reverse command signal is transmitted from the remote device 150-1 to the primary device 140 via the SIM 160. The remote device command receiver receives and demodulates the command signal according to its transmission method, such as frequency-shift keying (FSK) or on-off keying (OOK) transmission. The processor subsequently receives the demodulated command signals indicative of the requested action (e.g., requesting a presentation) and in accordance therewith instructs the tuner to tune to, for example, a channel carrying a real-time downstream signal, or the processor may retrieve a stored presentation from the storage device. The presentation's content signals are then provided to the modulator, which modulates the selected presentation prior to forwarding to the SIM 160. A preferred embodiment of the present invention uses a quadrature amplitude modulation (QAM) modulator, which may be used for effectively transmitting signals over coaxial cable in a cable television environment.

The presentations stored in the storage device of the primary device 140 include program identifiers (PIDs), which may be indexed and stored as a table in the primary device's memory. The remote devices 150-1 to 150-n may watch a single stored presentation by remapping the PID value of the stored program to a different PID value prior to modulation. In this manner, the single stored program basically remains in the storage device, while the transmitted presentation is a copy of the stored presentation having a remapped PID value.

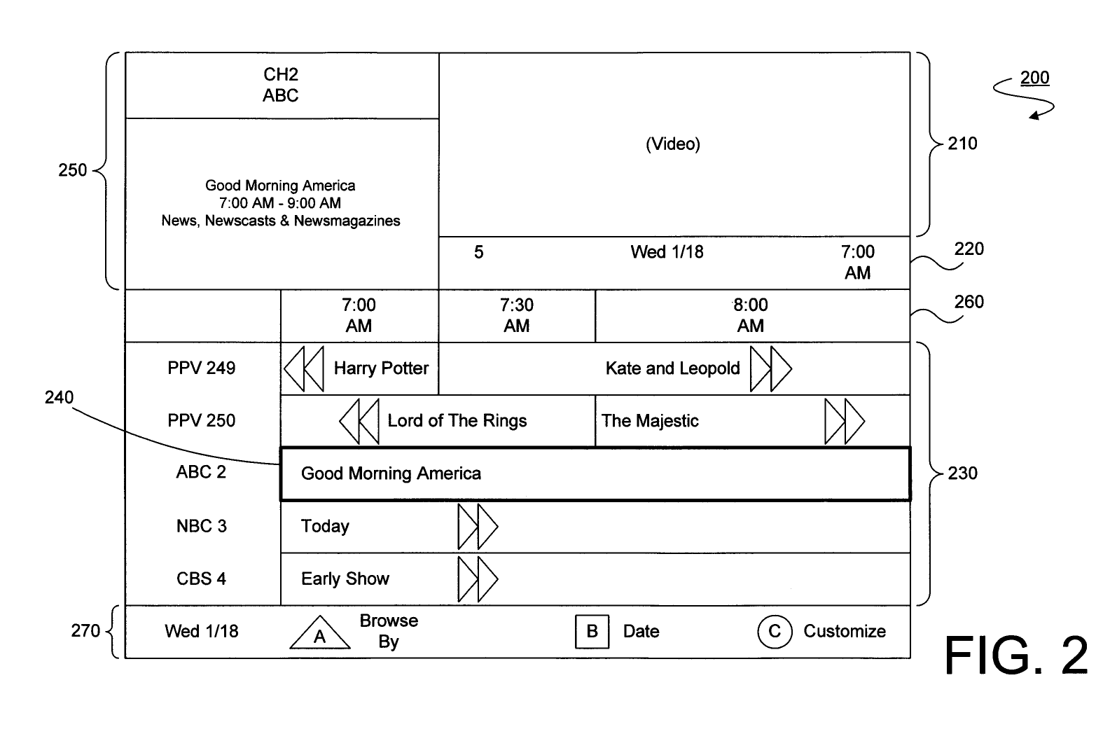

FIG. 2 illustrates a non-limiting example of an interactive program guide (IPG) screen 200 that is suitable for use in the NMS 110 of FIG. 1. The IPG screen 200 may be presented in response to user input that may be provided via the activation of a guide key on the remote control. In the top right of the IPG screen 200, video corresponding to the channel to which the primary device 140 is currently tuned may be displayed in the video screen 210. Immediately below the video area 210 is an information banner 220 for displaying the channel number corresponding to the channel to which the primary device 140 is currently tuned, the current day and date, and the current time.

In one embodiment, arrow buttons on the remote control can be used to scroll through a main presentation listing 230 and to highlight a desired presentation 240. The top left portion of the IPG screen 200 is a detailed focus area 250 that includes detailed information for a currently highlighted presentation 240. The detailed focus area 250 may include channel number, channel description, presentation name, duration of the presentation, and/or any episode information or rating. As a user scrolls in time across a calendar day boundary 260, the day and date indications displayed in various areas are updated. The bottom area 270 of the IPG screen 200 also indicates the current day for which presentation listing data is being displayed as well as information about the current functions of the optional “A,” “B,” and “C” keys that may be on the remote controls and are used in conjunction with the IPG. Further information regarding an interactive program guide can be found in copending U.S. patent application Ser. No. 10/212,017 filed on Aug. 2, 2002, the disclosure and teachings of which are hereby incorporated by reference.

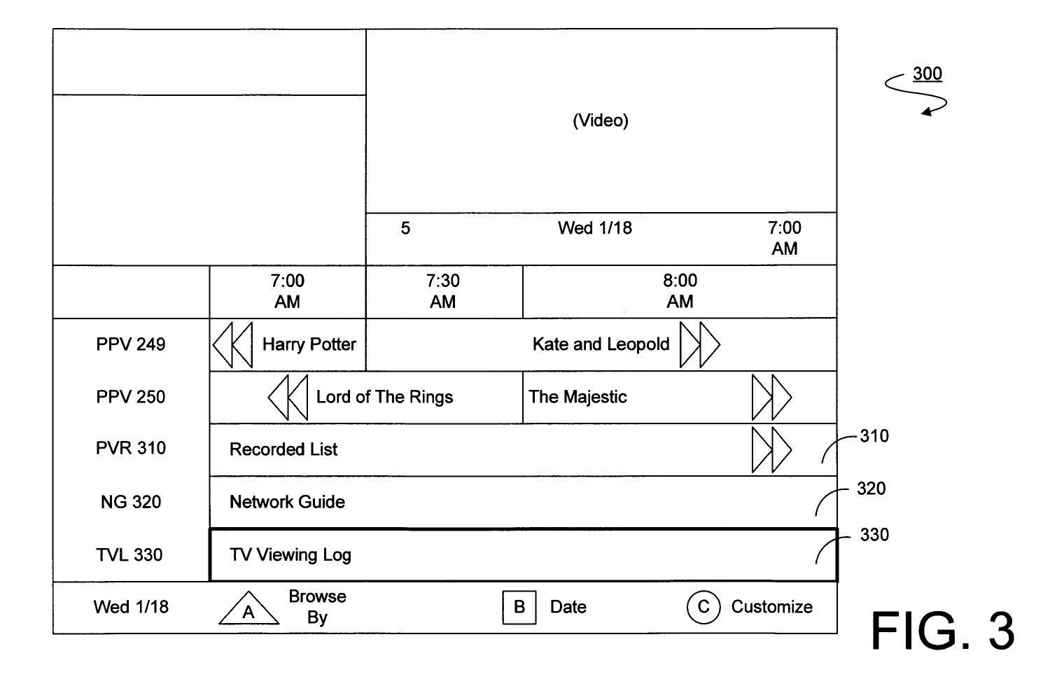

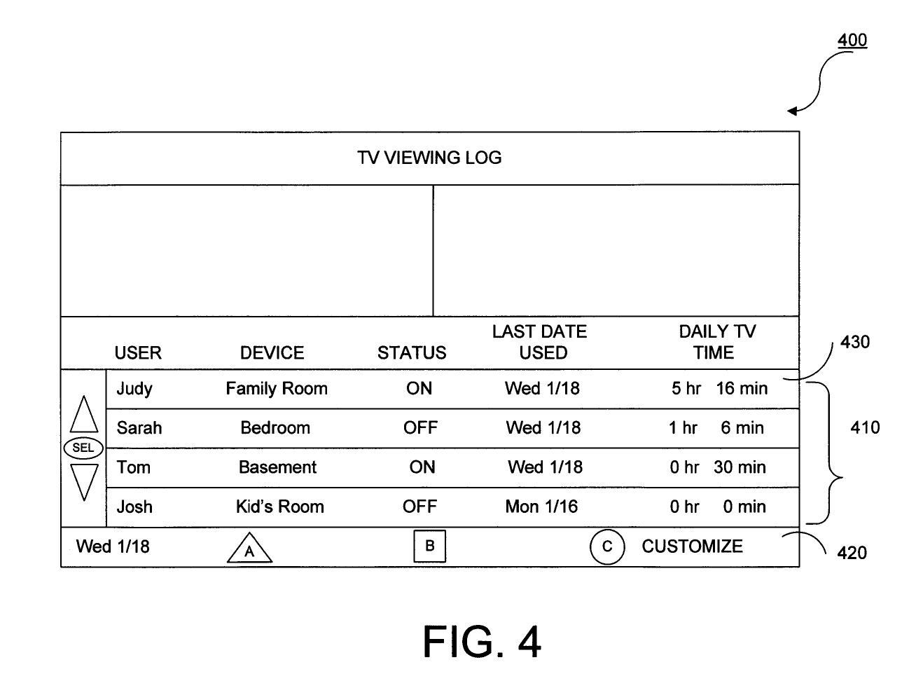

FIG. 3 illustrates the IPG 200 of FIG. 2 further including functionality listings, such as a personal video recording (PVR) listing 310, a network guide listing (NG) 320, and a television viewing log 330. Highlighting and selecting the television viewing log 330 accesses a television viewing log screen 400 as shown in FIG. 4. Alternatively, the user can select the channel number using number keypads on the remote control, such as entering the numbers 330. It will be appreciated by those skilled in the art that there are numerous ways by which the user interface can direct the user to the network guide listing 320 and/or the television viewing log 330. This channel-mapped interface is one example.

FIG. 4 depicts a non-limiting example of the television viewing log screen 400 showing a portion 410 of the viewing log that may be presented to the primary device 140 or the remote devices 150-1 to 150-n via the NMS 110 of FIG. 1. The bottom area 420 of the television viewing log screen 400 indicates the current day for which viewing data is being displayed. The portion of the television viewing log 410 displays a list that includes all of the STTs in a NMS 110 showing, for example, the name of the device, the user's name, the current status of the device, the last day the device was used, and the total television viewing time for the current day. As an example, line 430 shows that the device in the Family Room is currently on, being watched by Judy, and a total of 5 hours and 15 minutes have been watched on the device in the Family Room for Wednesday January 18^{th}.

The displayed information in the television viewing log screen 400 could be customized by the user. The user could specify the amount of television viewing time totaled, such as one day, a few days, or a week. The user could also determine whether the total viewing hours are totaled per user or per device. If the total is per user, each user would have to input an identification code before watching television on any STT. After the identification code has been entered, the total television viewing time for the specified time frame could be displayed or if there is a limit of television viewing in a specified time frame, the amount of remaining available television time for the user. The user could also specify that once the television viewing limit has been reached for a user, device, or a household the STT would cease to function until the specified time frame has ended. This could be overridden by entering an approved identification code.

Referring again to FIG. 4, a listing for a particular STT or for a particular user can be highlighted and more detailed information can be viewed by pressing a select button or a play button on a remote control. When a remote device 150-1, for example, requests line 430 containing the device “Family Room”, the processor accesses the viewing log data for this device, which is stored in memory, and subsequently forwards the content signals indicative of the Family Room device to the modulator for modulation and transmission to the requesting remote device 150-1. The user is then able to view the past programs viewed by the Family Room device.

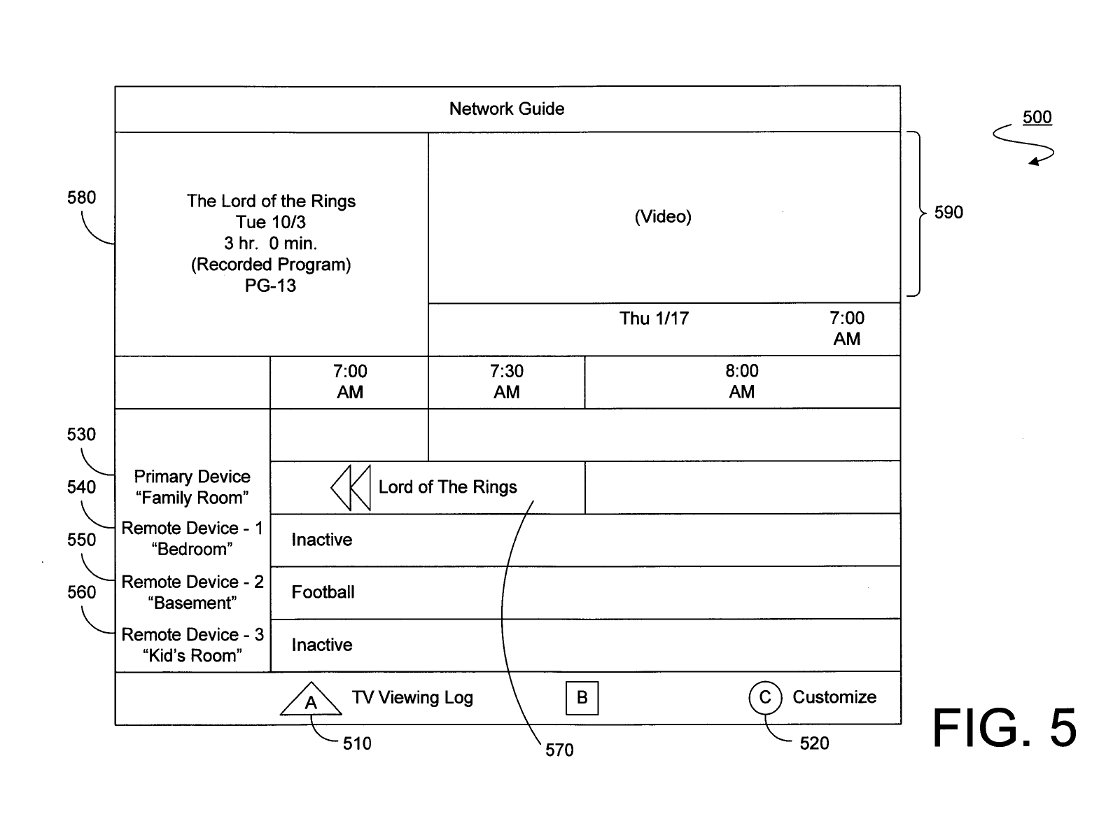

FIG. 5 illustrates the network guide 500 in accordance with the present invention that is suitable for use in the networked system 110 of FIG. 1. The network guide 500 provides an onscreen display of a program grid menu that includes a status history for each remote device 150-1 to 150-n including past and present presentations. The primary device 140 can easily store in memory, such as a hard drive, the past viewings of each remote device 150-1 to 150-n, thereby allowing a user to view any past history for a predetermined amount of time. It will be appreciated that the network guide 500 typically defaults to real-time viewing information. The “A” icon 510 and “C” icon 520 on the network guide screen 500 may correspond to “A” and “C” buttons on a remote control and perform additional operations.

The “A” icon 510 is labeled TV Viewing Log and would allow a user to see detailed information about the television viewing history of the household devices and users. For example, the user would press the “A” button on the remote control and the TV viewing log screen 400 would appear.

The “C” icon 520 is labeled Customize and would allow a user to customize the network guide 500, which is stored on the primary device 140, the primary device 140, and all of the remote devices 150-1 to 150-n. Upon customization of either the primary device 140 or one of the remote devices 150-1 to 150-n, the updated network guide 500 is saved with the new information. The primary device 140 then broadcasts, either upon request or in a carousel manner, the customized network guide 500 to the remote devices 150-1 to 150-n. Alternatively, the network guide 500 can be customized from any one or each of the remote devices 150-1 to 150-n. In this implementation, the user accesses the network guide 500 and uses a customization screen to customize each remote device individually or all of the primary device 140 and the remote devices 150-1 to 150-n in the NMS 110. Once customized, the remote device 150-1, for example, transmits the new information via the SIM 160 to the primary device 140 in order to update the network guide 500, which is stored in the primary device 140. The primary device 140 then broadcasts, either upon request or in a broadcast carousel, the customized network guide 500 including, for example, renamed remote device 150-1, to the plurality of remote devices 150-2 to 150-n.

Still referring to FIG. 5, the primary device 530, which has been named “Family Room,” is currently showing the presentation Lord of the Rings. Similarly, the network guide 500 displays the activity regarding the networked remote devices 150-1 to 150-n. Remote Device-1, having reference number 540, has been named “Bedroom” and is currently inactive. The network Remote Device-2 “Basement” 550 is currently watching Football. The network Remote Device-3 “Kid's Room” 560 is currently inactive (e.g., turned off or watching a movie via a connected VCR or DVD player). Primary Device “Family Room” 530 is presently showing a recorded presentation 570 of The Lord of the Rings. Additionally, a detailed focus area 580 displays the information regarding the highlighted presentation 570. For example, the presentation 570 of Lord of the Rings is a recorded program that was recorded on Tuesday, October 3, and the duration is three hours. There is also rating of PG-13 given for this presentation. The top right of the network guide 500 displays the real-time channel of the primary device 140 in the video screen 590. Unobtrusive parental monitoring can be allowed via the video screen 590 of the real-time channel or recorded presentation being watched on any of the remote devices 150-1 to 150-n to be shown in the video screen 590 when the particular presentation was highlighted in the network guide 500. For example, the presentation 570 of The Lord of the Rings is highlighted and the video would appear in the video screen 590 of the network guide 500.

The primary device 140 inherently knows what presentation each remote device 150-1 to 150-n is currently receiving when the presentations originate from the primary device 140. By way of example, the processor processes command signals from a remote device 150-1 requesting a stored presentation. The processor accesses the presentation from storage and routes the content signals indicative of the presentation to the modulator. The modulated presentation is subsequently provided to the remote device 150-1 via the SIM 160. The processor updates the network guide 500 with the presentation name and detailed information regarding the presentation along with the requesting remote device name and/or address. Similarly, the primary device 140 is aware of a tuned presentation (e.g., a television channel or a VOD presentation) that is provided to a remote device 150-1 via the tuner system in the primary device 140.

Because the primary device 140 is aware of each remote device 150-1 through 150-n, the television viewing log information can be stored on the hard drive of the primary device 140. The primary device 140 is aware of any change in status of the remote devices 150-1 to 150-n and can update the television viewing log as needed. If the television viewing log is tracking viewing time totals per user, the user entering their identification code will begin the television time tracking and turning off the device will end the television time tracking. If the user moves to a different device or returns to the same device later in the day, the current television time will be added to the television time total recorded earlier in the day.

There are times, however, when remote devices receive presentations without the assistance of the primary device 140. Some of the following examples may require only one tuner. However, some may require multiple tuners. For example, the remote device 150-2 may itself tune to a different television channel using an internal tuner system or the remote device may be turned off. Therefore, in one embodiment, the primary device 140 may request an indication of status from the remote device 150-2 in order to update the network guide 500. In which case, the processor in the primary device 140 sends a request signal to the remote device 150-2. In response, the remote device 150-2, via its processor, sends reverse command signals to the primary device 140's processor indicating its activity (e.g., presentation name, tuned channel, inactive, etc.). In another embodiment, each of the remote devices 150-1 to 150-n may send command signals updating their status on a regular basis. For example, the remote devices 150-1 to 150-n transmit reverse command signals indicating their activity every five seconds. In another embodiment, the remote devices 150-1 to 150-n may send command signals only when there is a change in activity (e.g., a channel change, power down, etc.), thereby potentially saving bandwidth. In another embodiment, the HE 120 can be used to relay messages between the primary device 140 and the remote devices 150-1 to 150-n. In yet another embodiment, if the tuners of the remote device 150-1 to 150-n can not be tuned to a multi-room QAM channel, a FSK demod can be added to each remote device 150-1 to 150-n so that each device knows the status of the others. It will be appreciated that in a further embodiment, the network guide 500 can be updated by using a combination of the embodiments.

The embodiments described above for relaying change of status information for remote devices 150-1 to 150-n could also be used to track television viewing on the television viewing log. Each of the above methods would allow for the primary device 140 to accurately monitor and record the television viewing for each device or each user. This information could be available to all household users or to specified users that would access the information with a special identification code. The information could also be cached on the hard drive of the primary device 140. The data could be sent to the HE 120 during off peak hours to conserve bandwidth or upon request from the HE 120. The data could be sent per user, per device, or aggregated for the entire household. The viewing data could also contain information on which programs, both tuned and saved, were watched and which programs were watched more than once and by which users or devices. To more efficiently use bandwidth, the data could also be compressed by the primary device 140 before being transmitted to the HE 120. Finally, because the primary device 140 is located inside the premises and has access to a storage device, such as an HDD, it is possible to make very detailed viewing logs and take advantage of a store-and-forward topology to update the HE 120 during non-peak network activity. The final result is a more detailed account of user activity than would be possible without making use of the storage device because of upstream bandwidth limitations.

It should be emphasized that the above-described embodiments of the invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and invention and protected by the following claims. In addition, the scope of the invention includes embodying the functionality of the embodiments of the invention in logic embodied in hardware and/or software-configured mediums.

What is claimed is:

1. A television viewing log for use in a networked multi-room system (NMS) comprising a viewing log arranged by user name or device name from a primary device in the NMS, and wherein said viewing log includes an indication of viewing data of said primary device and one or more remote devices of said NMS for a specified time period.

2. The NMS of claim 1, wherein said indication of viewing data is a record of presentations watched from one of said devices.

3. The NMS of claim 1, wherein said indication of viewing data is a total of the time one of said devices is presenting a presentation for display.

4. The NMS of claim 3, wherein one of said devices blocks all tuned and recorded signals if said viewing data exceeds a user specified total time.

5. The NMS of claim 1, wherein said indication of viewing data is a record of presentations watched by one of said devices and a corresponding total of time said one remote device is in use.

6. The NMS of claim 1, wherein said viewing data from said remote devices is received at said primary device by at least one of a request from said primary device, a change in status of said remote device, and a predetermined amount of time.

7. The NMS of claim 1, wherein said television viewing log is displayed as part of a network guide of the NMS.

8. The NMS of claim 7, wherein said network guide lists said television viewing guide.

9. The NMS of claim 1, wherein aggregated viewing data from said remote devices and said primary device in said NMS is received at a headend.

10. The NMS of claim 1, wherein an indication of status of one or more said remote devices is displayed on a network guide of said NMS.

11. The NMS of claim 10, wherein a status history of one or more said remote devices is recorded on said network guide and can be accessed by one or more said remote devices or said primary device.

12. The NMS of claim 1, wherein said viewing data from said remote devices is received and cached at said primary device by at least one of a request from said primary device, a change in status of said remote device, and a predetermined amount of time.

13. The NMS of claim 1, wherein said viewing data is compressed by said primary device.

14. The NMS of claim 1, wherein aggregated viewing data from said remote devices and said primary device in said NMS is received at a headend due to a request by said headend.

15. The NMS of claim 1, wherein aggregated viewing data from said remote devices and said primary device in said NMS is received at a headend during off-peak hours.

16. A television viewing log for use in a networked multi-room system (NMS) comprising a viewing log arranged by user name or device name from a primary device in the NMS; wherein said viewing log includes an indication of viewing data of one or more users of said primary device and one or more remote devices of said NMS for a specified time period.

17. The NMS of claim 16, wherein said indication of viewing data is a record of presentations watched by one of said users.

18. The NMS of claim 16, wherein said indication of viewing data is a total of the time one of said devices is presenting a program instance for display to one of said users.

19. The NMS of claim 16, wherein said indication of viewing data is a record of presentations watched by one of said users and a total of the time one of said remote devices is used by one of said users.

20. The NMS of claim 16, wherein an indication of status of one or more said users is displayed on a network guide of said NMS.

21. The NMS of claim 20, wherein a status history of one or more said users is recorded on said network guide and can be accessed by one or more said remote devices or said primary device.

22. The NMS of claim 16, wherein aggregated viewing data from said remote devices and said primary device in said NMS is received at a headend.

23. A method of collecting viewer data of a networked multi-room system (NMS), said method comprising the steps of:
providing a viewing log arranged by user name or device name from a primary device in the NMS; and
from said viewing log, providing an indication of viewing data of one or more users of said primary device and one or more remote devices of said NMS for a specified time period.

24. The method of claim 23, wherein said step of providing an indication of viewing data comprises displaying a record of presentations watched by one of said users.

25. The method of claim 23, wherein said step of providing an indication of viewing data comprises displaying a total of the time one of said devices is used by one of said users.

26. The method of claim 23, further comprising the step of blocking all tuned and recorded signals of one of said devices if said viewing data exceeds a user specified total time.

27. The method of claim 23, further comprising the step of displaying an indication of status of one or more said users on a network guide of said NMS.

28. The method of claim 27, further comprising the step of recording a status history of one or more said users on said network guide and accessing said status history by one or more said remote devices or said primary device.

29. The method of claim 23, further comprising the step of receiving aggregated viewing data from said users in said NMS at a headend.

30. A method of collecting viewer data of a networked multi-room system (NMS), said method comprising the steps of:
providing a viewing log arranged by user name or device name from a primary device in the NMS; and
from said viewing log, providing an indication of viewing data of said primary device and one or more remote devices of said NMS for a specified time period.

31. The method of claim 30, wherein said step of providing an indication of viewing data comprises displaying a record of presentations display from one of said devices.

32. The method of claim 30, wherein said step of providing an indication of viewing data comprises displaying a total of the time one of said devices is presenting a presentation for display.

33. The method of claim 30, further comprising the step of blocking all tuned and recorded signals of one of said devices if said viewing data exceeds a user specified total time.

34. The method of claim 30, wherein said step of providing an indication of viewing data comprises displaying a record of presentations displayed by one of said devices and a total of the time one of said remote devices is in use.

35. The method of claim 30, further comprising the step of displaying an indication of status of one or more devices on a network guide of said NMS.

36. The method of claim 35, further comprising the step of recording a status history of one or more said devices on said network guide and accessing said status history by one or more said remote devices or said primary device.

37. The method of claim 30, further comprising the step of receiving aggregated viewing data from said devices in said NMS at a headend.
